(19) United States
(12) Patent Application Publication
(10) Pub. No.: US 2026/0178933 A1
(43) Pub. Date: Jun. 25, 2026

(54) NEURAL NETWORK SYSTEM PERFORMING PARALLEL NEURAL NETWORK OPERATION

(71) Applicants: SK hynix Inc., Icheon-si (KR); Daegu Gyeongbuk Institute of Science and Technology, Daegu (KR)

(72) Inventors: Jongho PARK, Daegu (KR); Hoyeon LEE, Daegu (KR); Yeseong KIM, Daegu (KR); Minho HA, Icheon-si (KR); Byungil KOH, Icheon-si (KR)

(21) Appl. No.: 19/248,179

(22) Filed: Jun. 24, 2025

(30) Foreign Application Priority Data
Dec. 19, 2024 (KR) 10-2024-0190722

(51) Int. Cl. G06N 3/10; G06N 3/045

(52) U.S. Cl. CPC G06N 3/10; G06N 3/045

(57) ABSTRACT

A neural network system includes a host configured to store original parameters and perform a first operation by applying the original parameters to input data; and a pool memory including a memory array configured to store tuning parameters corresponding to the original parameters and an accelerator configured to perform a second operation by applying the tuning parameters to the input data.

### CROSS-REFERENCE TO RELATED APPLICATION

The present application claims priority under 35 U.S.C. § 119(a) to Korean Patent Application No. 10-2024-0190722, filed on Dec. 19, 2024, which is incorporated herein by reference in its entirety.

### BACKGROUND

### 1. Technical Field

Embodiments of the present disclosure relate to a neural network system that performs neural network operations in parallel on a host and on a pool memory.

### 2. Related Art

Large-scale neural networks, such as large language models (LLMs), pose challenges in retraining the entire network for specific applications.

To address this, fine-tuning techniques such as Low-Rank Adaptation (LoRA) and prefix tuning may be applied when providing services to various users using large-scale neural networks.

However, storing additional neural network parameters separately from core large-scale neural network parameters requires substantial memory, which can lead to increased memory usage and reduced computational efficiency.

### SUMMARY

In accordance with an embodiment of the present disclosure, a neural network system may include a host configured to store original parameters and perform a first operation by applying the original parameters to input data; and a pool memory including a memory array configured to store tuning parameters corresponding to the original parameters and an accelerator configured to perform a second operation by applying the tuning parameters to the input data.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and describe various principles and advantages of those embodiments.

FIG. 1 illustrates a neural network system according to an embodiment of the present disclosure.

FIGS. 2, 3A, and 3B illustrate tuning computing operations according to embodiments of the present disclosure.

FIG. 4 illustrates a neural network computing operation according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

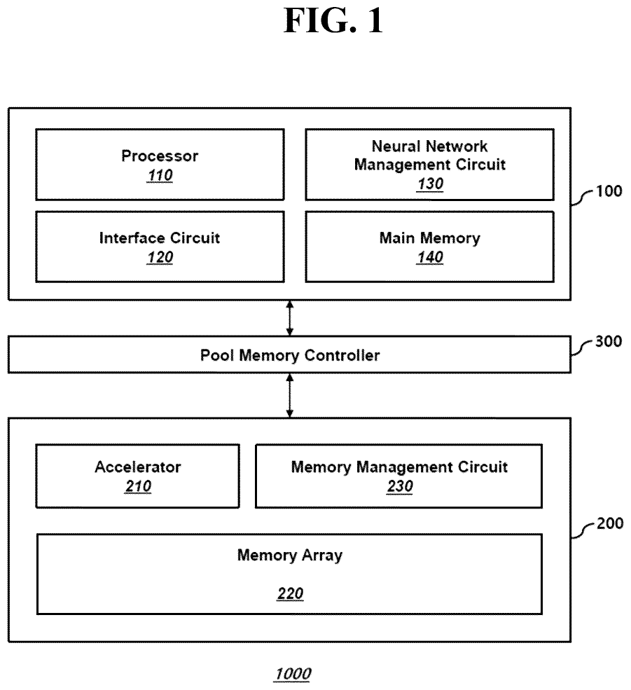

FIG. 1 is a block diagram showing a neural network system 1000 according to one embodiment of the present disclosure.

The neural network system 1000 includes a host 100, a pool memory 200, and a pool memory controller 300.

In this embodiment, the pool memory 200 is a compute express link (CXL)-based pool memory. However, the pool memory 200 is not limited thereto, and various memory pooling or memory sharing technologies may be applied.

Since a CXL protocol is based on a peripheral component interconnect express (PCIe) interface, the host 100, the pool memory controller 300, and the pool memory 200 may be connected via a PCIe interface.

The host 100 provides a memory request or an operation request to the pool memory controller 300.

The pool memory controller 300 generates a memory command or an operation command in response to the memory request or the operation request from the host 100, and controls the pool memory 200 using the memory command or the operation command.

In this embodiment, the host 100 communicates with the pool memory 200 via the pool memory controller 300. However, for simplicity, the following description of communication between the host 100 and the pool memory 200 omits the pool memory controller 300.

Although FIG. 1 illustrates a single host 100, multiple independently operating hosts may be included.

When multiple hosts are present, the pool memory 200 may include multiple dedicated address spaces, each exclusively allocated to a respective host, as well as shared address spaces accessible by two or more different hosts.

Since the allocation of address space can vary depending on design choices made by a person skilled in the art, a detailed description thereof is omitted.

The host 100 includes a processor 110, an interface circuit 120, a neural network management circuit 130, and a main memory 140.

The processor 110 controls the overall operation of the host 100 using an operating system, application programs, etc. loaded in the main memory 140. Since this is a well-known technology in the related art, a detailed description thereof is omitted.

The interface circuit 120 controls operations of transmitting and receiving memory requests and data based on the PCIe interface.

The neural network management circuit 130 may be implemented in hardware, software, or a combination thereof to control the overall neural network operation.

In the present technology, the neural network management circuit 130 controls the neural network operation using a fine tuning technique.

The main memory 140 stores parameters of an original neural network model that is the target of fine tuning. Hereinafter, the parameters of the original neural network model are referred to as original parameters.

The fine tuning may include techniques such as Low-Rank Adaptation (LoRA) and prefix tuning.

As the LoRA and the prefix tuning are well-known in the related art, detailed descriptions thereof are omitted.

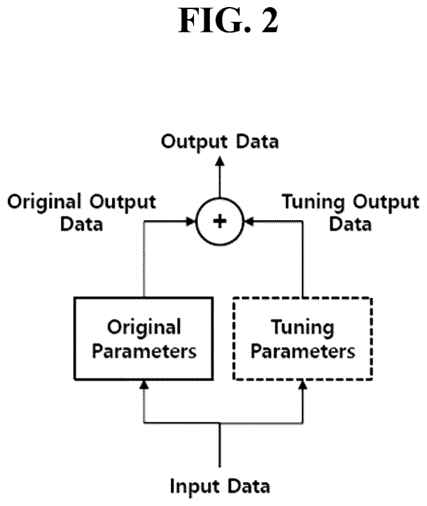

FIG. 2 illustrates the LoRA.

The LoRA is a technique that reduces the computational load during the fine tuning operation by learning small-sized tuning parameters instead of relearning the entire set of original parameters.

The tuning parameters can be applied wherever learnable parameters exist.

In FIG. 2, the dotted line represents the tuning parameters, while the solid line represents the original parameters.

The inference operation using the fine-tuned model is performed by combining the original output data, generated using the original parameters, with the tuning output data, generated using the tuning parameters.

Hereinafter, the operation using the original parameters is referred to as an ‘original operation’ or ‘first operation,’ while the operation using the tuning parameters is referred to as a ‘tuning operation’ or ‘second operation.’

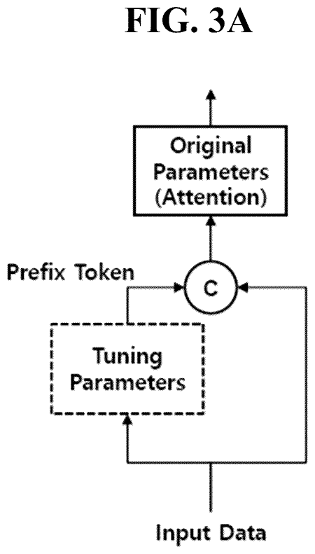

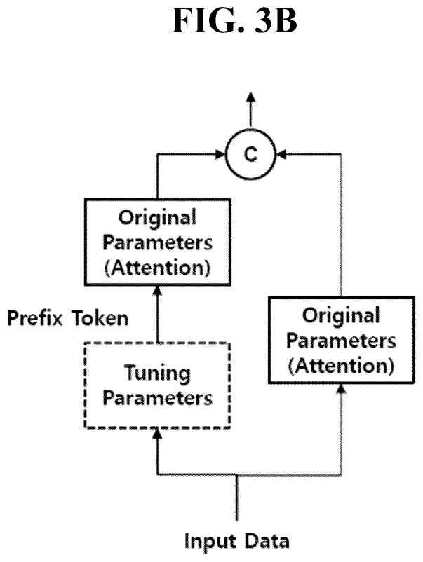

FIGS. 3A and 3B illustrate the prefix tuning.

As shown in FIG. 3A, the prefix tuning is a technique that enables a large language model (LLM) to generate user-customized responses by concatenating a prefix token in front of the input data provided to the LLM.

In FIGS. 3A and 3B, ‘attention’ refers to an operation performed in the encoding or decoding layer included in the LLM.

Prefix tokens are used in both learning and inference operations. During the learning operation, only parameters related to the prefix tokens are learned, rather than the entire LLM. During the inference operation, a learned prefix token corresponding to the input data is inserted.

In this context, the tuning parameters correspond to parameters used to generate the prefix token, while the original parameters correspond to all or part of the LLM.

In FIGS. 3A and 3B, the parameters related to the attention operation are indicated as the original parameters.

The operation shown in FIG. 3B is equivalent to that shown in FIG. 3A, illustrating that applying the attention operation to the result of concatenating the prefix token and the input data yields the same result as concatenating the outputs of the attention operation applied separately to the prefix token and the input data.

In this case, performing the attention operation on the input data corresponds to the first operation, and generating the prefix token from the input data and performing the attention operation on the prefix token corresponds to the second operation.

The pool memory 200 includes an accelerator 210, a memory array 220, and a memory management circuit 230.

The memory array 220 stores the aforementioned tuning parameters.

At this time, the tuning parameters can be managed and stored separately for each host 100.

If a plurality of applications in the host 100 are using the original parameters, the tuning parameters can be distinguished and stored based on the type of application running in the host 100.

The accelerator 210 controls the tuning operation by using the tuning parameters.

For example, in the LoRA technique shown in FIG. 2, the tuning operation that applies the tuning parameters to the input data is performed in the accelerator 210.

In addition, in the prefix tuning technique depicted in FIG. 3B, an operation of applying tuning parameters to the input data to generate a prefix token and performing an attention operation thereon can be performed in the accelerator 210.

The memory management circuit 230 receives the input data transmitted from the host 100 and transmits the result of the tuning operation performed in the accelerator 210 to the host 100.

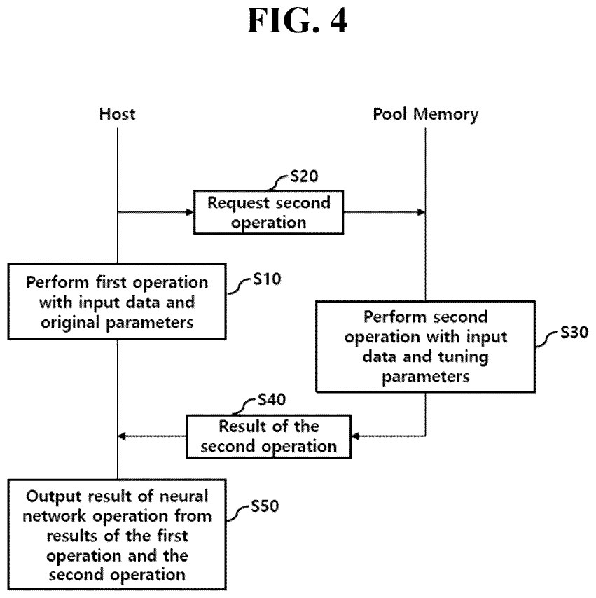

FIG. 4 is a flowchart showing a neural network operation according to an embodiment of the present disclosure. The neural network operation is described with reference to FIG. 1.

At S10, the host 100 performs a first operation by applying original parameters to input data.

At S20, the host 100 transmits a second operation request to the pool memory 200.

At S30, in response to the second operation request, the pool memory 200 performs a second operation by applying the tuning parameters to the input data.

At S40, the pool memory 200 transmits the result of the second operation to the host 100.

At S50, the host 100 outputs a result of a neural network operation by combining the results of the first and second operations.

In this embodiment, the first operation and the second operation can be performed in parallel by the host 100 and the pool memory 200, effectively hiding the delay time associated with communication between the host 100 and the pool memory 200.

Although various embodiments have been illustrated and described, various changes and modifications may be made to the described embodiments without departing from the spirit and scope of the invention as defined by the following claims. Furthermore, the embodiments may be combined to form additional embodiments.

What is claimed is:

1. A neural network system comprising:
a host configured to store original parameters and perform a first operation by applying the original parameters to input data; and
a pool memory including a memory array configured to store tuning parameters corresponding to the original parameters, and an accelerator configured to perform a second operation by applying the tuning parameters to the input data.

2. The neural network system of claim 1, wherein the host includes:
a main memory for storing the original parameters; and
a neural network management circuit configured to transmit a second operation request to the pool memory to perform the second operation for a neural network operation.

3. The neural network system of claim 2, wherein the pool memory further includes a memory management circuit configured to transmit a result of the second operation to the host, and
wherein the neural network management circuit generates a result of the neural network operation by combining a result of the first operation with the result of the second operation.

4. The neural network system of claim 2, wherein the neural network management circuit generates the second operation request so that the first operation and the second operation are performed in parallel.

5. The neural network system of claim 1, further comprising an additional host configured to access the pool memory independently of the host.
